(19) United States
(12) Patent Application Publication
(10) Pub. No.: US 2023/0143411 A1
(43) Pub. Date: May 11, 2023

(54) HEAT GENERATOR AND A METHOD FOR GENERATING HEAT

(71) Applicant: Timofey Mochalov, Sosensky (RU)

(72) Inventor: Timofey Mochalov, Sosensky (RU)

(21) Appl. No.: 17/529,300

(22) Filed: Nov. 18, 2021

(30) Foreign Application Priority Data
Nov. 5, 2021 (LT) 2021570

(51) Int. Cl. F24H 1/10; H05B 7/12; H05B 7/08

(52) U.S. Cl. CPC F24H 1/106; H05B 7/12; H05B 7/08; F24H 2250/10

(57) ABSTRACT

Method for generating heat energy comprising supplying electrical energy to a heating element where the heating element heats a negatively charged cathode, electrons are emitted from the heated cathode towards a positively charged anode through a positively charged grid, wherein the positively charged grid is provided with greater charge potential value that the anode and the anode is forced to constantly generate heat energy, wherein at least part of the cathode, the positively charged grid and at least part of the anode are provided in hydrogen gas filled chamber of a container. A device for carrying out said method is also disclosed.

### CROSS REFERENCE TO RELATED APPLICATIONS

This patent application claims the benefit of an earlier filed foreign application, LT2021-570 filed Nov. 5, 2021. The above application is incorporated by reference herein.

### FIELD OF THE INVENTION

The present invention relates to a field of thermal energy generation by electric component. In particular, the invention relates to a device and a method for obtaining thermal energy for heating end consumers and for reverse conversion using thermoelectric generators into electrical energy from electric voltage driven heat source in particular an electronics component.

### BACKGROUND ART

A common thermal energy source for end consumer heating application is an electric heating element operating on the principle of a resistive heating, occurring whenever an electric current flows through a material that has some resistance Ω. The heat corresponds to the work done by the charge carriers in order to travel to a lower potential φ.

A U.S. patent application Ser. No. 11/731,190 (publication No. US20080240689A1) discloses a space heater having an electrical resistance heating element, radiating heat when an electric current flows through the resistive element. Main disadvantage of such heating element is that it requires a considerable amount of electrical energy to power it and the efficiency of conversion of electrical energy into heat energy is very low.

Thermal energy can also be produced in power switch devices such as triodes, tetrodes, pentodes, etc. Further devices may be manufactures employing working principles of the aforementioned. Such devices are for example thyratrons, based on working principles of triodes, tetrodes and pentodes. The triodes, tetrodes and pentodes are vacuum tubes, filled with gas used for low voltage switching applications, thyratrons are vacuum devices also filled with gas but intended for high voltage switching applications. A common thyratron is disclosed in scientific publication Design and Simulation of Thyratron Switch Using for Pulse Forming Network by Hooman Mohammadi Moghadam, Conference: 4th National Conference on Applied Research in Electrical and Computer Science and Medical Engineering At: Shirvan. Thyratrons may be filled with hydrogen. The hydrogen thyratron may be used as a power switch that tolerates high voltage and current in the linear accelerator modulator. The thyratron switch based on a triode consists of three main parts: anode, cathode, grid, which can be switched on and off by using a proper grid voltage. Hydrogen gas is used because it is more durable and is more tolerable to voltage than other gases, commonly used in vacuum-type switching devices.

Commonly for all power switching devices in common application in electronics a characteristic effect called dynatron effect may occur. This effect causes the power switching devices to generate harmful excessive heat. The heat is undesirable and the power switching devices are manufactured and operated so that to avoid causing the dynatron effect. The dynatron effect is characterized by transfer of secondary emission electrons from anode to a third electrode, called a grid. Bombarding the anode with high-energy electrons, emitted from cathode after heating the cathode, knocks out secondary emission electrons from the anode. If, at the same time, potential of the grid exceeds potential of the anode, then the secondary electrons emitted from the anode do not return to the anode but are attracted to the grid. The electric current in the anode decreases, the current in the grid electrode increases producing excessive heating which has a negative effect on the components of the vacuum lamp and surrounding electronic components. To prevent secondary emission, a high supply voltage is necessary in the dynatron region. In all conventional electro-vacuum devices, the dynatron effect is structurally suppressed and considered harmful.

The disclosed invention does not have the disadvantage of low conversion efficiency of conversion of electrical energy to heat energy.

### SUMMARY OF THE INVENTION

Method for generation of heat energy comprises proving a housing and providing within the housing a chamber comprising a first electrode an anode, having a positively charged first part. The chamber further comprises at least part of a negatively charged electrode, called a cathode, at least a positively charged grid electrode and optionally a negatively charged grid electrode. The housing is a vacuum type sealed housing comprising hydrogen gas in the chamber of the housing. Preferably, hydrogen gas is present in the chamber at the proportion of 1-10% of the total volume of the chamber.

When the cathode is heated by direct heating or indirect heating, electrons are emitted from the first part of the anode through the hydrogen filled chamber of the housing.

The first part of the anode and the positively charged grid are made of a refractory material such as of molybdenum, tungsten, or other similar materials, since the dynatron effect is promoted and strong heating of the anode for carrying out the method occurs. When the device is operating the anode can be heated up to 1000-2000 C.° degrees and above, and the conversion of electrical energy into heat is approaching 100%.

### BRIEF DESCRIPTION OF THE DRAWINGS

Features of the invention believed to be novel and inventive are set forth with particularity in the appended claims. The invention itself, however, may be best understood by reference to the following detailed description of the invention, which describes exemplary embodiments, given in non-restrictive examples, of the invention, taken in conjunction with the accompanying drawings, in which:

FIG. 1 shows principal scheme of embodiment of heat generator with one grid in between the cathode and the anode, the grid being positively charged grid.

FIG. 2 shows principal scheme of embodiment of heat generator with two grids in between the cathode and the anode, one grid, closer to the cathode is a negatively charged grid, and another grid, closer to anode is a positively charged grid.

FIG. 3 principal scheme of embodiment of heat generator with two grids in between the cathode and the anode: one grid, closer to the cathode is a negatively charged grid, and another grid, closer to anode is a positively charged grid, where the cathode, both grids and the anodes are shaped as hollow cylindrical bodies and where diameter of the cathode is greater than diameter of the anode and the hollow space of the cylindrical body of the anode is dedicated for flow of cooling liquid. The outer surface of the container in one case is a surface of a container which body is made of material having good heat conductive and heat resistance properties, such as metal with a high melting point, metal ceramics, ceramics. The outer surface of the container in another case is an outer surface of a cathode wherein the container body is made of the cathode.

FIG. 4 shows principal scheme of embodiment of heat generator with two grids in between the cathode and the anode, one grid, closer to the cathode is a negatively charged grid, and another grid, closer to anode is positively charged grid, where the cathode, the grids and the anodes are shaped as hollow cylindrical bodies and where diameter of the anode is greater than diameter of the cathode. In one case the outer surface of the cylindrical body of the anode is dedicated for flow of cooling liquid and constitutes body of the container. In another case the outer surface of the container is a surface of a container which body is made of material having good heat conductive and heat resistance properties, such as metal with a high melting point, metal ceramics, ceramics and where the hollow cylindrical body of the cathode has smaller diameter than diameter of the container

FIG. 5 shows a principal scheme of application of heat generator according to the invention for space heating and for thermoelectric power generation using in a space heater comprising air blowing means when the container of the heat generator is disposed with respect to the air blowing means so that cathode end of the container is closer to the air blowing means than the end with anode.

FIG. 6 shows a principal scheme of application of heat generator according to the invention for space heating and for thermoelectric power generation using in a space heater comprising air blowing means when the container of the heat generator is disposed with respect to the air blowing means so that cathode end and anode end of the container would be at the same distance from the air blowing means.

FIG. 7 shows a principal scheme of application of heat generator according to the invention for space heating and for thermoelectric power generation using liquid cooling circuit to cool down the anode and the surface of the container.

FIG. 8 shows a principal scheme of application of heat generator according to the invention for space heating and for thermoelectric power generation using liquid cooling circuit to cool down the anode by passing the cooling liquid through hollow space of the cylindrical hollow anode.

FIG. 9 shows a principal scheme of application of heat generator (HG) according to the invention for space heating and for thermoelectric power generation using liquid cooling circuit to cool down the anode by passing the cooling liquid around the outer surface of the cylindrical hollow anode. The anode constitutes the container body.

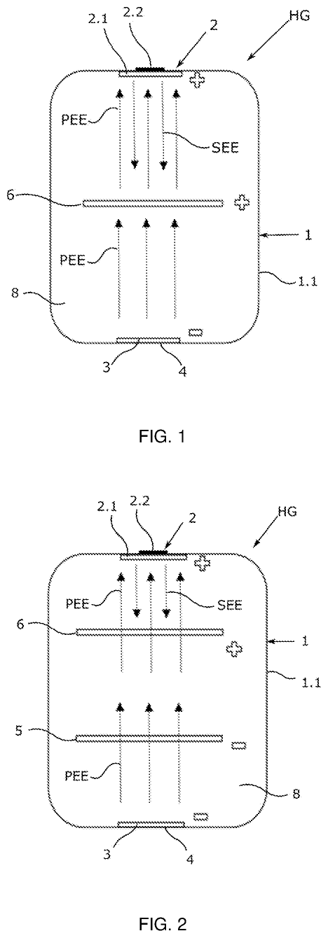

Preferred embodiments of the invention will be described herein below with reference to the drawings. Each figure contains the same numbering for the same or equivalent element.

### DETAILED DESCRIPTION OF THE INVENTION

It should be understood that numerous specific details are presented in order to provide a complete and comprehensible description of the invention embodiment. However, the person skilled in art will understand that the embodiment examples do not limit the application of the invention which can be implemented without these specific instructions. Well-known methods, procedures and components have not been described in detail for the embodiment to avoid misleading. Furthermore, this description should not be considered to be constraining the invention to given embodiment examples but only as one of possible implementations of the invention.

The heat generator (HG) according to the invention comprises a container (1); an anode (2), having positively charged first part (2.1), which is a heat generating part and is disposed in a hydrogen gas comprising chamber (8), and a second part (2.2), which is heat dissipation to the outside of the container (1) means; a negatively charged electrode (3), called a cathode (3), at least partially disposed in a hydrogen gas comprising chamber (8); an optional cathode heater (4), used when the cathode (3) is a direct heating filament; an optional negatively charged grid (5) for accelerating electrons from a negatively charged electrode (3); a positively charged grid (6), having charge exceeding charge of the positively charged first part (2.1) of the anode (2). The container (1) comprises a tightly sealed container body (1) housing the first part (2.1) of the anode (2), at least part of the cathode (3), optionally the cathode's direct heater (4), when the cathode (3) is a direct heating filament, optionally the negatively charged grid (5), the positively charged grid (6) in a tightly sealed hydrogen gas filled chamber (8) of the container (1).

In all embodiments of the invention, the cathode (3) may be implemented as a direct heating filament, in which case the cathode's direct heater (4) is present in the container (1) for heating the cathode (3). Thus, the direct heater (4) of the cathode (3) is optional. The cathode (3) may also be implemented as an indirect heating cathode (3), in which case the direct heater (4) is omitted. In all embodiments of the invention the cathode (3) is a heatable cathode (3).

In all embodiments of the invention the first part (2.1) of the anode (2), the cathode (3), the optional cathode's direct heater (4), used when the cathode (3) is direct heating filament, the positively charged grid (6) and the optional negatively charged grid (5) each comprise nodes (not shown) for connecting to electrical circuit of the heat generator (HG) for control of operation of the first part (2.1) of the anode (2), the cathode (3), the optional cathode heater (4), the positively charged grid (6) and the optional negatively charged grid (5). The nodes are preferably disposed on the outside of the container (1) and are electrically connected with the respective electrodes (2.1, 3, 4, 5, 6).

In all embodiments of the invention the anode (2) is disposed so that the first part (2.1) of the anode (2) is at last partially disposed in the chamber (8) of the container (1) and the second part (2.2) which is means (2.2) for heat removal from the first part (2.1) of the anode (2) to the outside of the container (1) is disposed on the outside of the container (1). The first part (2.1) and the second part (2.2) are interconnected so that heat generated by the first part (2.1) is fluidly transferred to the second part (2.2) and to the outside of the container (1).

When the entire container (1) is configured for immersion into a heat removing medium the heat is removed from entire outer surface (1.1) of the container (1) and the second part (2.2) of the anode (2). When the heat is removed only from the second part (2.2) of the anode the container (1) is insulated to prevent heat dissipation through the outer surface (1.1) of the container (1).

In embodiments of the invention where the container (1) has a body which is not essentially constituted of the anode (2) or the cathode (3), the body of the container (1) is preferably made of a metal or metal alloy with a high melting point, metal ceramics or ceramics. In such embodiments the body of the container (1) must withstand very high temperatures and not burn out or melt, as well as serve as secondarily heat removal means, since the container (1) may also heat up from the heat of the first part (2.1) of the of the anode (2) when the heat from the first part (2.1) of the anode (2) is not sufficiently removed and the container (1) is allowed to heat up and serve as a secondary heat removal means for dissipating heat via outer surface (1.1) of the container (1).

In embodiments of the invention where the body of the container (1) is essentially constituted of the anode (2) or the cathode (3), the hydrogen gas is contained in a chamber (8) delimited by inner surface of respectively the anode (2) or the cathode (3).

The optional negatively charged grid (5) is situated between the cathode (3) and the positively charged grid (6), wherein the positively charged grid (6) is situated between the first part (2.1) of the anode (2) and the negatively charged grid (5). The negatively charged grid can take a neutral value or be positive charge value to enhance operation of the heat generator (HG).

Hydrogen gas is present in the chamber (8). The hydrogen is one of the most important initiators of the heat generation process. Preferably, hydrogen gas is present in the chamber (8) at the proportion of 1-10% of the total volume of the chamber (8). If greater part of the volume or entire volume is filled with hydrogen, then harmful effect, such as a hydrogen explosion from a spark or an arc discharge in hydrogen according to the principle of a thyratron will take place.

The first part (2.1) of the anode (2) and the positive grid (6), and the optional negative grid (5) are made of a refractory material such as molybdenum, tungsten, or other similar materials, for working in strong excessive heating conditions inside the chamber (8) of the container (1). The main excessive heat source is the first part (2.1) of the anode (2). Preferably, the first part (2.1) of the anode (2) is made of molybdenum, the cathode (3) and the grids (5, 6) are made of tungsten.

The first part (2.1) of the anode (2) and the cathode (3) are coated with material that promotes increased electron yield to enhance electron emission from the first part (2.1) of the anode (2), the secondary electron emission (SEE), and the cathode (3), the primary electron emission (PEE). Preferably the coating material is an oxide such as zirconium oxide, thorium oxide, barium oxide.

During operation of the heat generator (HG) the cathode (3) is heated directly by the heater (4) or indirectly. Heating of the cathode (3) prompts release of electrons (PEE) from the cathode (3) in the direction of the first part (2.1) of the anode (2) in the medium of hydrogen gas. After the electrons (PEE) are released from the cathode (3) they are optionally accelerated forwards by a negatively charged grid (5). After the electrons (PEE) passes the optional negatively charged grid (5), high-energy electrons (PEE) pass a positively charged grid (6) and knocks out secondary emission electrons (SEE) from the first part (2.1) of the anode (2). When the optional negatively charged grid (5) is not disposed in the chamber (8), the primary electrons (PEE) from the cathode (3) pass the positively charged grid (6) and knocks out secondary emission electrons (SEE) from the first part (2.1) of the anode (2).

To promote secondary emission of electrons (SEE) from the first part (2.1) of the anode (2) the positively charged grid (6) has positive potential greatly exceeding positive potential of the first part (2.1) of the anode (2). The secondary emission electrons (SEE) emitted from the first part (2.1) of the anode (2) do not return to the first part (2.1) of the anode (2) but are attracted to the positively charged grid (6). Electric current in the first part (2.1) of the anode (2) increases, producing excessive heating. Preferably, the positive potential of the positively charged grid (6) should exceed the positive potential on the first part (2.1) of the anode (2) by 50-100% or greater percentage.

The heat generator (HG) constantly operating in excessive heat generation mode, i.e., in dynatron effect mode, causes maximum secondary electron emission (SEE) and subsequently maximum conversion of the supplied electric energy into heat energy. The first part (2.1) of the anode (2), as the main source of generated heat, can heat up to 1000-2000 C.° or more and the conversion of electrical energy into heat is approaching 100%.

The operation of the heat generator (HG) is controlled by controlling voltage at the cathode (3) and at the positive grid (6) and/or negative grid (5), the principle is the same as for controlling a conventional triode, when only positive grid (6) is used, or tetrode, when negative and positive grid (5, 6) are used.

### SPECIFIC EXAMPLES OF EMBODIMENTS AND IMPLEMENTATIONS OF THE SAME

The generated heat from the primary heat source, the first part (2.1) of the anode (2), is transferred to for space heating purposes, thermoelectric energy generation or alike.

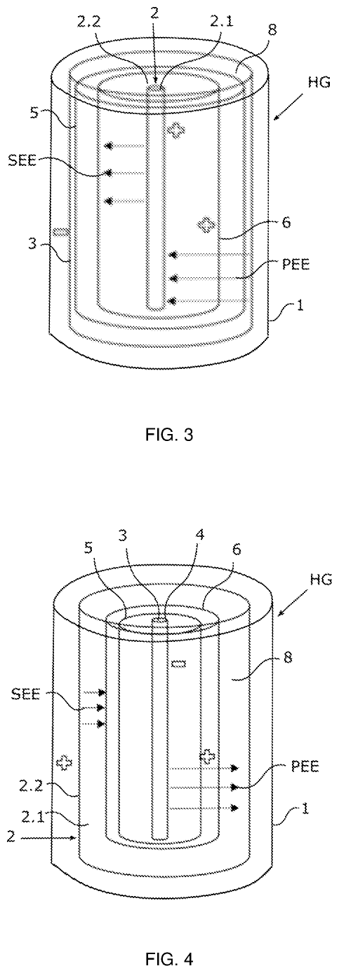

In one embodiment of the invention and as shown in FIG. 3, the heat generator (HG) is formed in a shape of a cylinder. The cathode (3) is formed as an elongated hollow cylindrical body. The cathode (3) heater is disposed close by on the outside of the cylindrical body of the cathode (3) when the cathode (3) is a direct heating filament. The cathode heater (4) is omitted when the cathode (3) is an indirect heating filament cathode (3). The optional negatively charged grid (5) is also shaped as a hollow cylindrical body having smaller diameter than the cathode (3) and is disposed inside the hollow of cylindrical body of the cathode (3). The positively charged grid (6) is also shaped as a hollow cylindrical body and has smaller diameter than the optional negatively charged grid (5) and is disposed inside the hollow of cylindrical body of the optional negatively charged grid (6), or inside the hollow of cylindrical body of the cathode (3), when the negatively charged grid (5) is not present. The anode (2) is also shaped as a hollow cylindrical body and has smaller diameter than the positively charged grid (6) and is disposed inside the hollow of cylindrical body of the positively charged grid (6). The first part (2.1) of the anode (2) comprises at least outer surface of the hollow cylindrical body of the anode (2) and the second part (2.2) of the anode (2) comprises at least inner surface of the hollow cylindrical body of the anode (2). All the elements (2, 3, 5, 6) are disposed in the cylindrical container (1) concentrically. For purpose of heat removal from the first part (2.1) of the anode (2), the inner cylindrical space of the anode (2) is configured for flow (WF) of a heat transferring liquid (W), such as water or a conventional coolant. The cathode (3) may constitute the body of the container (1) or the body of the container may be formed as a further cylindrical hollow body having a diameter greater than that of the cathode (3).

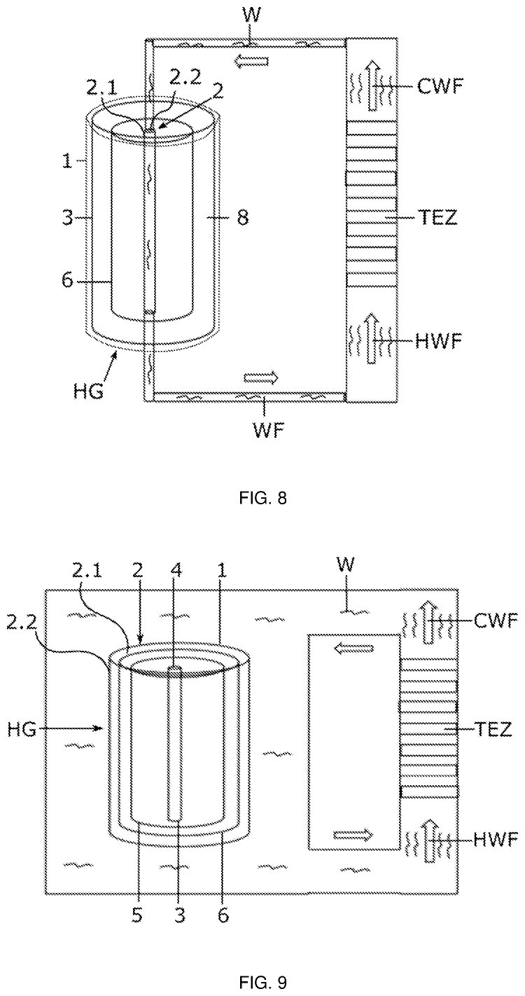

In implementation of such embodiment and as shown in FIG. 8, the heat transferring liquid (W) cools down the second part (2.2) of the anode (2) and transfers a heated liquid (HWF) for further use for space heating by a dedicated heat removal zone. The circuit of such implementation may also include a heat removal zone (TEZ) specifically designed for thermoelectric energy generator.

In another embodiment of the invention and as shown in FIG. 4 the heat generator (HG) is formed in a shape of a cylinder. The cathode (3) is formed as an elongated hollow cylindrical body. the cathode heater (4) is disposed inside the cylindrical body of the cathode (3) when the cathode (3) is a direct heating filament. The cathode heater (4) may be omitted when the cathode (3) is an indirect heating filament cathode (3). The optional negatively charged grid (5) is also shaped as a hollow cylindrical body having greater diameter than the cathode (3) and is disposed around the cylindrical body of the cathode (3). The positively charged grid (6) is also shaped as a hollow cylindrical body and has greater diameter than the optional negatively charged grid (5) and is disposed around the cylindrical body of the optional negatively charged grid (6), or around the cylindrical body of the cathode (3), when the optional negatively charged grid (5) is not present. The anode (2) is also shaped as a hollow cylindrical body and has greater diameter than the positively charged grid (6) and is disposed around the cylindrical body of the positively charged grid (6). All the elements (2, 3, 5, 6) are disposed in the cylindrical container (1) concentrically. The first part (2.1) of the anode (2) comprises at least inner surface of the hollow cylindrical body of the anode (2) and the second part (2.2) of the anode (2) comprises at least outer surface of the hollow cylindrical body of the anode (2). For purpose of heat removal from the anode (2), the second part (2.2) of the anode (2) is configured for dissipation of heat by flow (WF) of a heat transferring liquid (W), such as water or conventional coolant. The anode (2) may constitute the body of the container (1) or the body of the container may be formed as a further cylindrical hollow body having a diameter greater than that of the anode (2).

In implementation of such embodiment and as shown in FIG. 9, the heat transferring liquid cools down the second part (2.2) of the anode (2) and transfers the heated liquid (HWF) for further use for space heating by a dedicated heat removal zone. The circuit of such implementation may also include a heat removal zone (TEZ) specifically designed for thermoelectric energy generator.

In yet another embodiment of the invention and as shown in FIG. 2, when the cathode (3) is a direct heating filament, the cathode heater (4) is disposed below the cathode (3) at first end of the chamber (8) of the somewhat cylindrical body of the container (1). The cathode heater (4) may be omitted when the cathode (3) is an indirect heating filament cathode (3). Further from the cathode (3) the optional negatively charged grid (5) is disposed covering essentially entire diameter of the chamber (8). Further from the optional negatively charged grid (5) or further from the cathode (3), when the optional negatively charged grid (5) is not present, a positively charged grid (6) is disposed covering essentially entire diameter of the chamber (8). Further from the positively charged grid (6) the first part (2.1) of the anode (2) is disposed at second end of the chamber (8) at least partially in the chamber of the somewhat cylindrical body of the container (1). The first end of the chamber (8) is directly opposite the second end of the chamber (8). The body of the container (1) is preferably made of a metal or metal alloy with a high melting point, metal ceramics or ceramics.

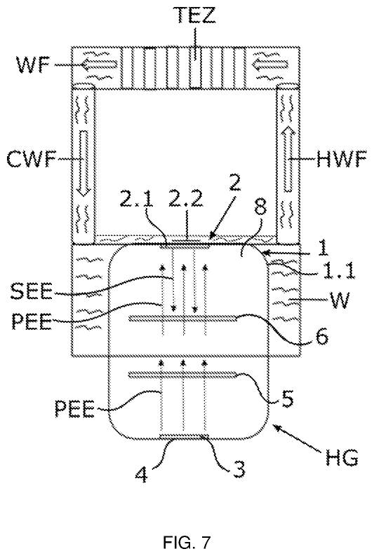

In implementation of such embodiment and as shown in FIG. 7, the heat from the heat generator (HG) is removed by forcing a flow of cooling liquid (W) such as water or coolant liquid around the end of the container (1) which has heat transfer means (2.2), the second part (2.2) of the anode (2), for transferring heat from the first part (2.1) of the anode (2), disposed inside the container (1), to the outside of the container (1). Outer surface (1.1) of the container (1) is also used for dissipating heat from the chamber (8) of the container (1) to the flowing liquid (WF). The body of the container (1) is preferably made of a metal or metal alloy with a high melting point, metal ceramics or ceramics. The heat transferring liquid (WF) cools down the first part (2.1) of the anode (2) and transfers the heated liquid (HWF) for further use for space heating by a dedicated heat removal zone. The circuit of such implementation may also include a heat removal zone (TEZ) specifically designed for thermoelectric energy generator.

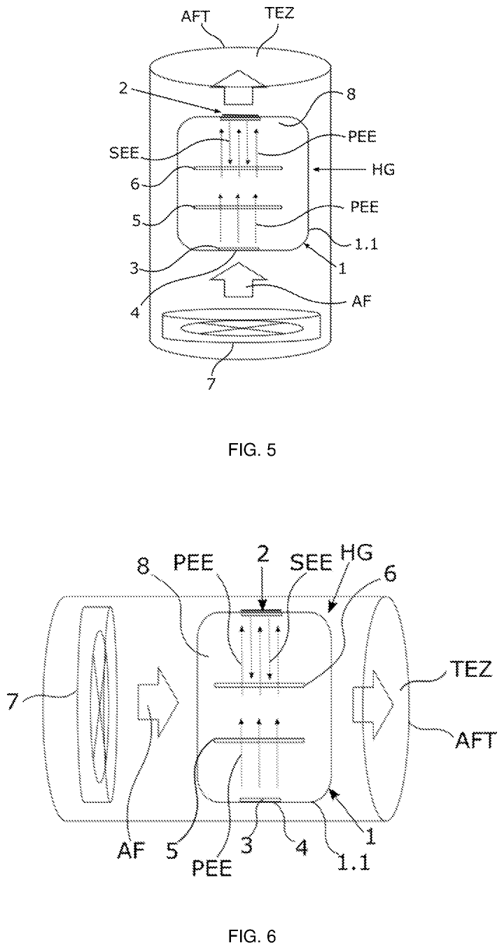

In implementation of such embodiment and as shown in FIGS. 5 and 6, the heat from the heat generator (HG) is removed by forcing a flow (AF) of gas or gas mixture, such as air, around the entire container (1), preferably surrounded by a gas flow guiding and containing walls (AFT) or at least end of the container which has heat transfer means (2.2), for transferring heat from the first part (2.1) of the anode (2), disposed inside the container (1), to the outside of the container (1). Outer surface (1.1) of the container (1) is also used for dissipating heat from the chamber (8) of the container (1) to the flowing air. The body of the container (1) is preferably made of a metal or metal alloy with a high melting point, metal ceramics or ceramics. The heat transferring air cools down the first part (2.1) of the anode (2) and transfers the heated air for further use for space heating. The circuit of such implementation may also include a heat removal zone (TEZ) specifically designed for thermoelectric energy generator. The container (1) of the heat generator (HG) is either disposed with respect to the air blowing means so that cathode (3) end of the container (1) is closer to the air blowing means than the end with anode (2), or the container (1) of the heat generator (HG) is disposed with respect to the air blowing means so that cathode (3) end and anode (2) end of the container (1) would be at the same distance from the air blowing means.

In all examples of applications of embodiments of the invention the heat removal means (7), for removing heat from the heat generator (HG), comprises a fluid medium and fluid flow inducing means, where the fluid medium is a liquid or gas which is being forced to flow by a flow inducing means and thus cool down the second part (2.2) of the anode (2) and the outside surface (1.1) of the container (1).

In all embodiments of the invention, where each of the anode (2), the cathode (3), the positively charged grid (6) and the negatively charged grid (5) are shaped as elongated hollow cylindrical body, they are shaped as elongated hollow open-ended cylindrical bodies. In embodiments where anode (2) or the cathode (3) are shaped as elongated hollow cylindrical body and essentially constitute the body of the container (1), respectively the anode (2) and the cathode (3) are closed-ended to form a sealed container (1) body.

Although numerous characteristics and advantages together with structural details and features have been listed in the present description of the invention, the description is provided as an example fulfilment of the invention. Without departing from the principles of the invention, there may be changes in the details, especially in the form, size and layout, in accordance with most widely understood meanings of the concepts and definitions used in claims.

1. A heat generator comprising an electrical heat generating element characterized in that it comprises:
a container,
an anode with a positively charged first part for secondary electron emission, being made of refractive material and coated with material that promotes increased electron yield,
a negatively charged heatable cathode, for primary electron emission, being made of refractive material and coated with material that promotes increased electron yield,
a positively charged grid, having a charge exceeding the charge of the positively charged first part of the anode, and being made of refractory material,
a second part of the anode having heat removal means for removing heat generated in the container by the first part of the anode in the presence of hydrogen gas;
wherein the container is a tightly sealed container housing, in a hydrogen filled chamber, the first part of the positively charged electrode, at least part of the negatively charged heatable cathode, the positively charged grid, where the positively charged grid has positive potential greatly exceeding the positive potential of the first part of the anode.

2. The heat generator according to claim 1, wherein a negatively charged grid configured to accelerate electrons from a negatively charged cathode is disposed in the container between the cathode and the positively charged grid.

3. The heat generator according to claim 1, wherein the hydrogen gas is present in the chamber at the proportion of 1-10% of the total volume of the chamber.

4. The heat generator according to claim 1 where the coating material of the cathode and the first part of the anode is an oxide selected form a list of zirconium oxide, thorium oxide, barium oxide.

5. The heat generator according to claim 1 wherein the positively charged grid (6) exceeds the positive potential on the first part of the anode by 50-100% or greater percentage.

6. The heat generator according to claim 1 wherein the heatable cathode is formed as an elongated hollow cylindrical body, the positively charged grid is also shaped as a hollow cylindrical body and has smaller diameter than the cylindrical body of the cathode and is disposed inside the hollow of cylindrical body of the cathode, the anode is also shaped as a hollow cylindrical body and has a smaller diameter than the positively charged grid and is disposed inside the hollow of cylindrical body of the positively charged grid, wherein the anode, the cathode, the negatively charged grid, and the positively charged grid are disposed in the chamber of the cylindrical container concentrically, wherein for the purpose of heat removal from the first part of the anode, the inner cylindrical space of the anode comprises the second part of the anode and is dedicated for flow of a heat transferring liquid.

7. The heat generator according to claim 6, where a negatively charged grid shaped as a hollow cylindrical body and having smaller diameter than the cathode is disposed inside the hollow of cylindrical body of the cathode between the cathode and the positively charged grid.

8. The heat generator according to claim 1, wherein the cathode is formed as an elongated hollow cylindrical body, with a heater disposed inside the cylindrical body of the cathode, the positively charged grid is also shaped as a hollow cylindrical body and has greater diameter than the cylindrical body of the cathode and is disposed around the cylindrical body of the cathode, the anode is also shaped as a hollow cylindrical body and has greater diameter than the positively charged grid (6) and is disposed around the cylindrical body of the positively charged grid, wherein the anode, the cathode, the negatively charged grid, and the positively charged grid are disposed in the chamber of the cylindrical container concentrically wherein for purpose of heat removal from the first part of the anode, the second part of the anode is dedicated for flow of a heat transferring liquid.

9. The heat generator according to claim 8, wherein a negatively charged grid shaped as a hollow cylindrical body and having greater diameter than the cathode is disposed around the cylindrical body of the cathode between the cathode and the positively charged grid.

10. The heat generator according to claim 1, wherein the heatable cathode is disposed at first end of the chamber of the somewhat cylindrical body of the container, further from the cathode the positively charged grid is disposed covering essentially entire diameter of the chamber, further from the positively charged grid the first part of the anode is disposed at second end of the chamber of the cylindrical body of the container.

11. The heat generator according to claim 2, where the negatively charged grid is disposed between the heatable cathode and the positively charged grid covering essentially entire diameter of the chamber.

12. Method for generating heat energy comprising supplying electrical energy to an electrical heat generator for heating characterized in that a negatively charged heatable cathode is heated and electrons are emitted from the heated cathode towards a positively charged first part of an anode through a positively charged grid, wherein the positively charged grid is provided with greater charge potential value that than the first part of the anode and the first part of the anode is forced to constantly generate heat energy, wherein at least part of the heatable cathode, the positively charged grid, and at least part of the anode are disposed in the presence of hydrogen gas in a chamber of a container.

13. Method according to claim 12, where the primary electrons are accelerated from the cathode by a negatively charged grid being provided between the cathode and the positively charged grid.

14. The method according to claim 12, wherein hydrogen gas is present in the chamber at the proportion of 1-10% of the total volume of the chamber.

15. Method according to claim 12, wherein the positively charged grid exceeds the positive potential on the first part of the anode by 50-100% or greater percentage.

16. Method according to claim 12, wherein the first part of the anode heats up to 1000-2000 C.° or more and the conversion of electrical energy into heat is approaching 100%.
